(19) United States
(12) Patent Application Publication
(10) Pub. No.: US 2014/0331964 A1
(43) Pub. Date: Nov. 13, 2014

(54) Dual Fuel Engine Diagnostic System And Method Of Operating Same

(71) Applicant: Caterpillar, Inc., Peoria, IL (US)

(72) Inventors: Steven Thomas Grant, Groveland, IL (US); Frank Lombardi, Metamora, IL (US); Daniel R. Puckett, Peoria, IL (US); Alan R. Stockner, Metamora, IL (US)

(73) Assignee: Caterpillar, Inc., Peoria, IL (US)

(21) Appl. No.: 13/890,671

(22) Filed: May 9, 2013

(51) Int. Cl. F02D 19/06; F02M 43/00

(52) U.S. Cl. CPC F02D 19/0602; F02M 43/00
USPC 123/304

(57) ABSTRACT

A compression ignition engine is fueled from common rail fuel injectors that predominately inject natural gas fuel that is compression ignited with a small pilot injection of liquid diesel fuel. Prior to servicing the engine, a service tool may establish a communication link with an electronic controller that controls operation of the engine. Pressure information for a gaseous fuel common rail and a liquid fuel common rail are displayed with the service tool, when the engine is stopped, in order to determine whether the rails are completely depressurized indicating that it is then o.k. to perform servicing tasks.

### TECHNICAL FIELD

The present disclosure relates generally to servicing dual fuel compression ignition engines, and more particularly to a serviceability algorithm that displays common rail pressure information with a service tool.

### BACKGROUND

Natural gas is increasingly becoming an attractive alternative for fueling internal combustion engines. In one specific example, a compression ignition engine is fueled predominately with natural gas originating from a gaseous fuel common rail, and liquid diesel fuel from a liquid fuel common rail, that are directly injected into each engine cylinder. Both fuels are injected from the same fuel injector, and the relatively large charge of gaseous fuel is ignited by compression igniting a small pilot injection quantity of liquid diesel fuel. Co-owned U.S. Patent Application Publication No. 2012/0285417 shows an example of such a dual fuel system.

Almost all engines must be serviced from time to time in order to tend to malfunction warnings and for routine maintenance. In some instances, a service tool may establish a communication link with an engine electronic controller in order to receive fault codes and other information relating to engine hardware and fluid conditions. However, assuring proper depressurization may be a prerequisite to servicing either of the common rails.

The present disclosure is directed toward one or more of the problems set forth above.

### SUMMARY

In one aspect, an engine diagnostic system includes an engine with a plurality of pistons that reciprocate in cylinders to define a compression ratio greater than 14:1. The engine includes an electronic controller in control communication with a dual fuel common rail system. The dual fuel common rail system includes a gaseous fuel common rail and a liquid fuel common rail fluidly connected to a plurality of the fuel injectors positioned for direct injection of gaseous fuel and liquid fuel directly into the cylinders. A service tool is in communication to the electronic controller and programmed to execute a serviceability algorithm configured to display pressure information for the gaseous fuel common rail and the liquid fuel common rail when the engine is stopped.

In another aspect, a method of operating the engine diagnostic system includes establishing a communication between the service tool and the electronic controller. A serviceability algorithm is executed with the service tool. With the engine stopped, pressure information for the gaseous fuel common rail and the liquid fuel common rail are displayed responsive to execution of the serviceability algorithm.

### BRIEF DESCRIPTION OF THE DRAWINGS

FIG. 1 is a schematic view of engine diagnostic system according to an aspect of the present disclosure;

FIG. 2 is a perspective view of a portion of the engine shown in FIG. 2;

FIG. 3 is a sectioned perspective view through a portion of the engine shown in FIG. 2;

FIG. 4 is a sectioned side view of a concentric quill assembly for supplying gaseous and liquid fuels to individual fuel injectors;

FIG. 5 is a front sectioned view of a fuel injector for the engine of FIGS. 2-5;

FIG. 6 is an enlarged sectioned view of a control portion of the fuel injector of FIG. 5; and

FIG. 7 is an example logic flow diagram for a serviceability algorithm according to the present disclosure.

### DETAILED DESCRIPTION

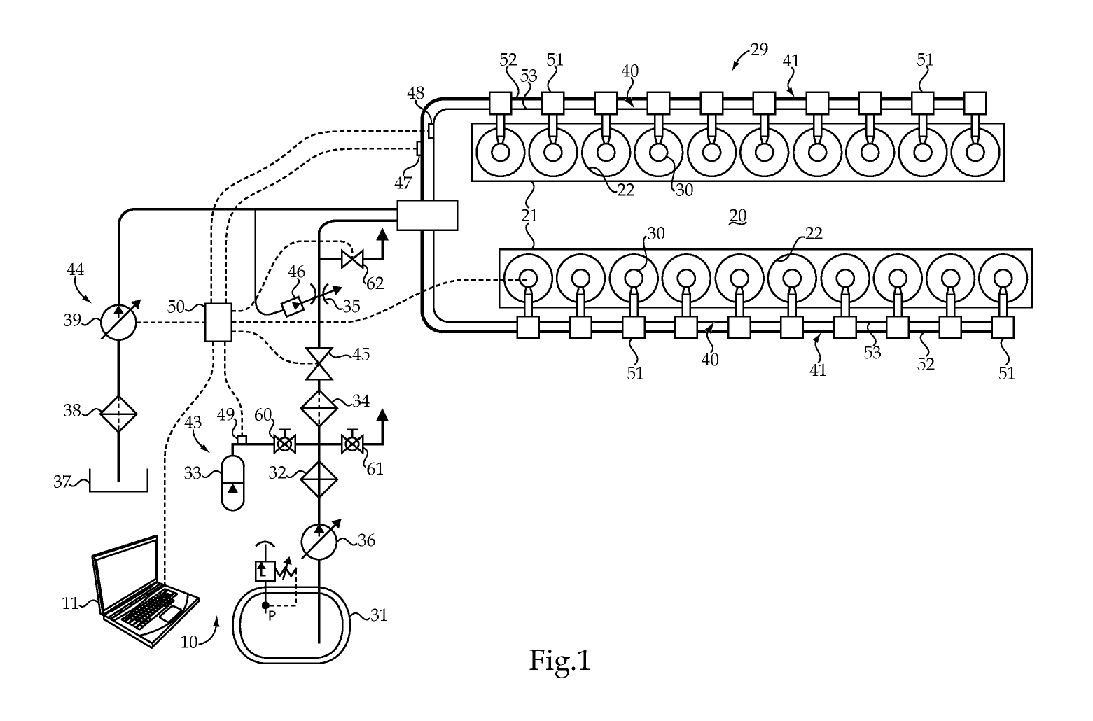

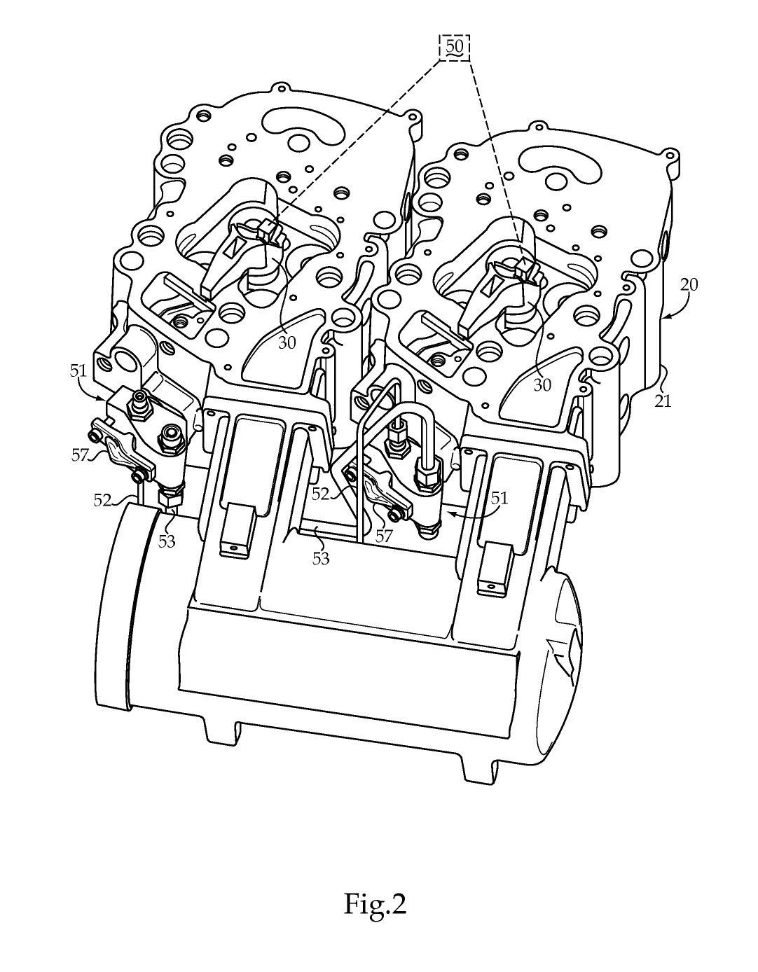

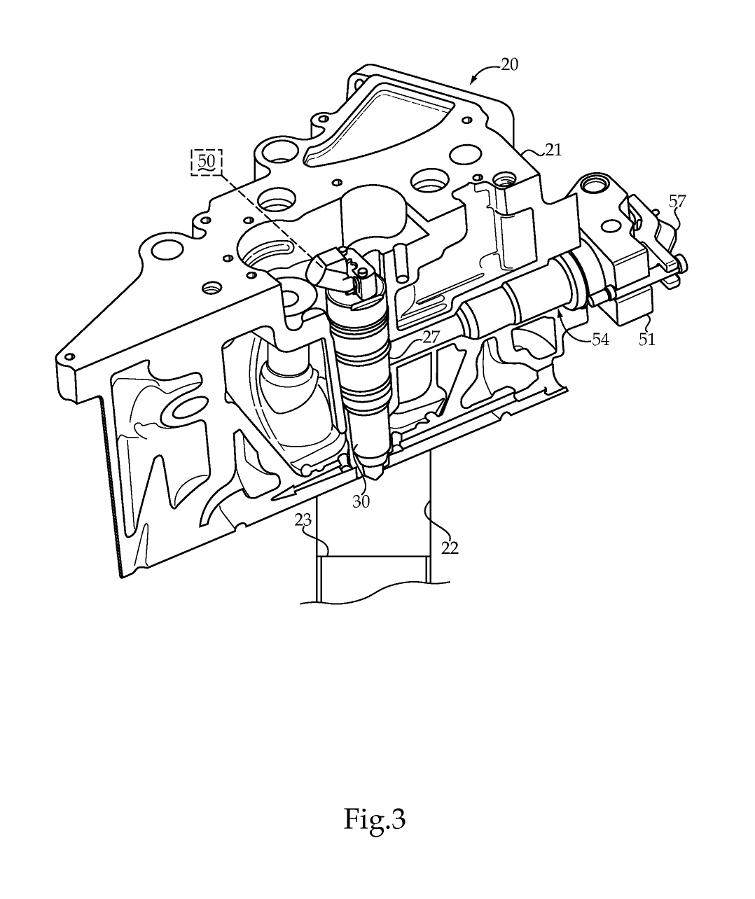

Referring initially to FIGS. 1-4, an engine diagnostic system 10 includes a service tool 11 in communication with an electronic controller 50 of an engine 20 that includes a dual fuel common rail system 29. The dual fuel engine 20 includes an engine housing 21 that defines a plurality of engine cylinders 22. A piston 23 reciprocates in each of the cylinders 22 to define a compression ratio greater than 14:1, which is generally associated with a compression ratio suitable for compression igniting injected liquid diesel fuel. In the illustrated embodiment, engine 20 includes twenty engine cylinders 22. However, those skilled in the art will appreciate that an engine with any number of cylinders would also fall within the intended scope of the present disclosure. The dual fuel common rail system 29 includes exactly one fuel injector 30 positioned for direct injection into each of the plurality of engine cylinders 22. The dual fuel common rail system 29 includes a gaseous fuel common rail 40 and a liquid fuel common rail 41 that are fluidly connected to a gaseous fuel inlet 101 and a liquid fuel inlet 102, respectively, of each fuel injector 30. The dual fuel common rail system 29 includes gas supply devices 43 that supply gaseous fuel to the gaseous fuel common rail 40.

The gas supply devices 43 may include a pressurized cryogenic liquid natural gas tank 31 with an outlet fluidly connected to a variable delivery cryogenic pump 36, and may also include a heat exchanger 32 (vaporizer), an accumulator 33 and a gas filter 34. The accumulator 33 is fluidly positioned between vaporizer 32 and gaseous fuel common rail 40. A gas supply metering valve 35 may be fluidly positioned between accumulator 33 and the gaseous fuel common rail 40. The metering valve 35, which could be dome regulator valve, may be included to control a mass flow rate of gaseous fuel to the gaseous fuel common rail 40 by changing a variable flow area. This strategy also inherently controls the pressure in gaseous fuel common rail 40. In the illustrated embodiment, the pressure of gaseous fuel in gaseous fuel common rail 40 is controlled responsive to pressure in the liquid fuel common rail 41 using a pressure actuator 46 that changes a variable flow area through the metering valve 35 via a fluid connection to liquid fuel common rail 41. Although the gaseous rail pressure is shown as being regulated hydro-mechanically, responsive to pressure in the liquid fuel common rail, those skilled in the art will appreciate that other strategies could be used for controlling pressure in the gaseous fuel common rail 40. For instance, an electronically controlled valve could be substituted in place of the metering valve 35 shown without departing from the present disclosure. In the illustrated embodiment, it may be desirable to calibrate metering valve 35 in order to control the gas rail pressure toward a pressure that is lower than the liquid rail pressure in order to inhibit migration of gaseous fuel into the liquid fuel.

A shutoff valve 45 may be located to isolate gaseous fuel common rail 40 from the gaseous fuel supply devices 43, namely the accumulator 33 and cryogenic pump 36. Liquid supply and pressure control devices 44 may include a diesel fuel tank 37, fuel filters 38 and an electronically controlled high pressure fuel pump 39 that supplies liquid fuel to, and controls pressure in, liquid fuel common rail 41. The electronic controller 50 may be in control communication with shutdown valve 45, the liquid supply and pressure control devices 44, the gaseous supply devices 43 as well as each of the fuel injectors 30. Pressure sensors 47 and 48 may communicate liquid and gaseous fuel pressures, respectively, to electronic controller 50. A pressure sensor 49 may communicate vaporizer 33 pressure information to electronic controller 50.

In the illustrated embodiment, engine 20 may also equipped with a venting valve 62 that is movable between a first configuration at which the gaseous fuel common rail 40 is fluidly blocked to atmosphere, and a second position at which the gaseous fuel common rail 40 is fluidly connected to atmosphere. Venting valve 62 is shown as being controlled via communication with electronic controller 50, but could be a manual valve. Venting valve 62 will normally be closed at almost all times when engine 20 is running or stopped. However, in certain circumstances, such as when engine 20 is being serviced, venting valve 62 may be moved to its second configuration to fluidly connect gaseous fuel common rail 40 to atmosphere in order to assure depressurization in the event that a portion of gaseous fuel common rail 40 is opened elsewhere for servicing, such as replacement of one or more fuel injectors 30. Engine 20 is also shown as being equipped with a manual isolation valve 60 and a manual venting valve 61. Isolation valve 60 would normally be in an open position, but may be manually closed to isolate accumulator 33 from the remaining portions of the system to perform some test or servicing task. Likewise, manual venting valve 61 may be utilized to vent accumulator 33 to atmosphere in order to assure depressurization if one or more of the other components such as vaporizer 32, filter 34 or accumulator 33 are being serviced. Manual venting valve 61 is normally always in a closed configuration, whereas isolation valve 60 is normally maintained in an open configuration.

Among other things, service tool 11 may be programmed to execute a serviceability algorithm configured to display pressure information for the gaseous fuel common rail 40 and the liquid fuel common rail 41 when engine 20 is stopped. This information may be made available to electronic controller 50 from pressure sensors 47 and 48, and then communicated via electronic controller 50 to service tool 11. The displayed pressure information should be sufficient to allow a technician to determine whether one or both of the gaseous fuel common rail 40 and/or the liquid fuel common rail 41 are at atmospheric pressure, indicating that it is then o.k. to service portions of dual fuel common rail system 29. For instance, if one or more of the fuel injectors 30 were being replaced, such an action could open the gaseous and liquid fuel common rails 40, 41 to atmosphere at co-axial quill 54. In addition, the serviceability algorithm executed by service tool 11 may also display pressure information for accumulator 33 as communicated to electronic controller 50 by pressure sensor 49. Execution of the serviceability algorithm may also be configured to disable operation of engine 20 in order to avoid problems associated with accidently attempting to start engine 20 while being serviced. For instance, the serviceability algorithm could be provided with fuel injector disable parameters that would prevent fuel injectors 30 from being operated when the serviceability algorithm was being executed and engine 20 was being serviced. The pressure information displayed by service tool 11 may be as sophisticated as is desired, or may simply be a message indicating whether or not it is o.k. to service engine 20. One of the purposes of the serviceability algorithm is to ensure that technicians and/or the location where the engine 20 is being serviced are not opened in a pressurized condition the could result in a stream of fuel spraying from a service location in or on engine 20. The same information displayed by service tool 11 may also be available at another location, such as an operator station of a machine equipped with engine 20.

In addition to determining whether pressure conditions in the common rails 40, 41 are suitable for servicing (e.g., at atmospheric pressure), other pertinent information may also be available to a technician using service tool 11. For instance, fluid temperatures in the cryogenic liquefied natural gas tank 31, and maybe the temperature of liquid diesel fuel in common rail 41 may also be scrutinized prior to servicing certain aspects of engine 20. In addition, the cryogenic pump 36 may be hydraulically powered, and the hydraulic fluid associated with that pump may also have temperature and pressure protocols that could be reviewed by a serviceability algorithm prior to servicing those aspects of engine 20. Thus, in a broader sense, the serviceability algorithm might monitor various sub-system parameters and compare them to predefined thresholds for confirming a so-called zero energy state condition suitable for permitting servicing to one or more of the subsystems. The serviceability algorithm might provide a summary of each system state displayed by the service tool 11, and may be in-cab display of an operator control station.

Although not necessary, the gaseous fuel common rail 40 and the liquid fuel common rail 41 may be made up of a plurality of daisy chained blocks 51 that are connected in series with liquid fuel lines 52 and gaseous fuel lines 53. The liquid and gaseous fuels may be supplied to the individual fuel injectors 30 with a coaxial quill assembly 54 that includes an inner quill 55 that is positioned within an outer quill 56. Liquid fuel is supplied to the fuel injector 30 through inner quill 55, and gaseous fuel is supplied to fuel injector 30 in the space between inner quill 55 and outer quill 54. A load adjusting clamp 57 may be utilized with each block 51 for pushing the coaxial quill assembly 54 so that both the inner quill 55 and the outer quill 56 seat on a common conical seat 27 of each fuel injector 30.

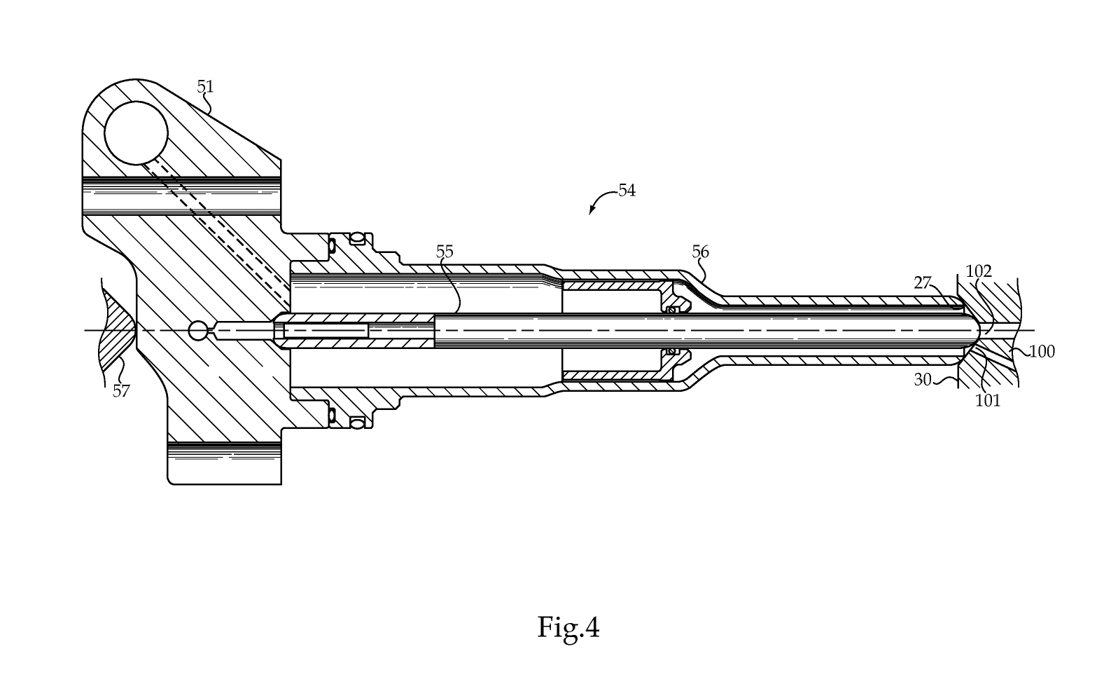

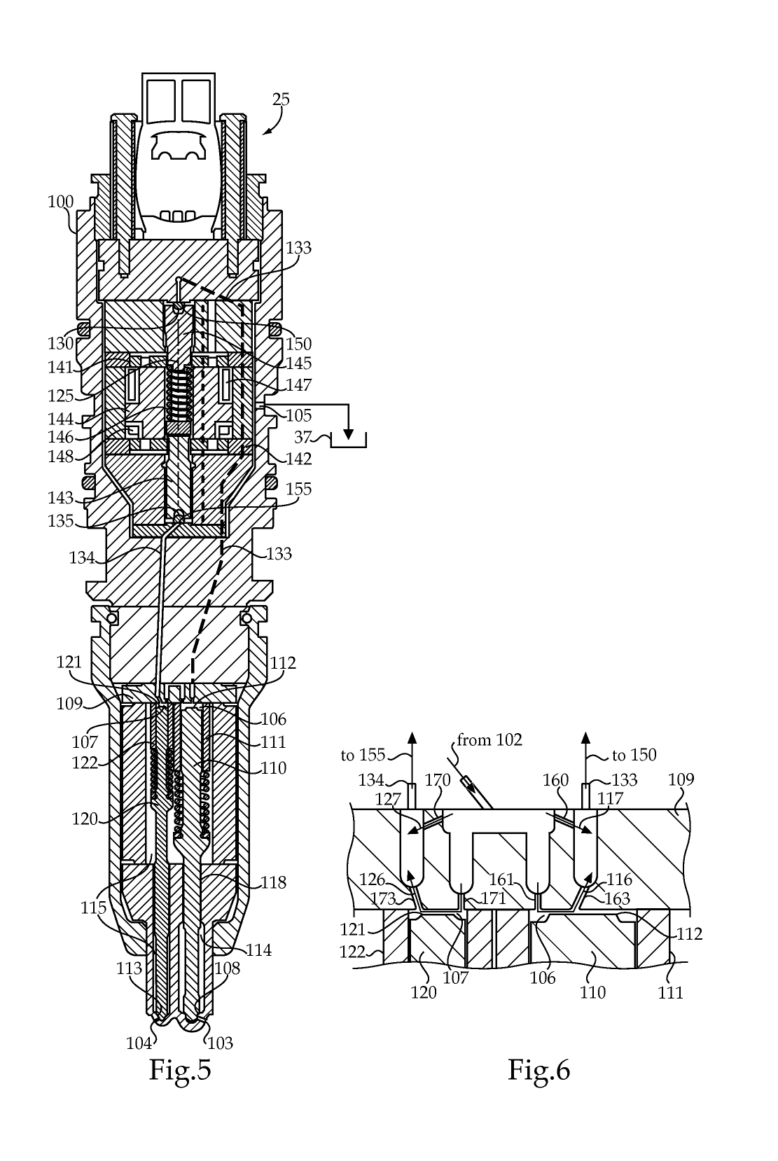

Referring in addition to FIGS. 5 and 6, an example fuel injector 30 for use in the engine 20 is illustrated. Fuel injector 30 includes an injector body 100 that defines a gaseous fuel inlet 101 for gaseous fuel and a liquid fuel inlet 102 for liquid fuel that both open through common conical seat 27 (FIG. 4). The gaseous fuel inlet 101 is fluidly connected to a gaseous nozzle chamber 114 disposed within injector body 100 via a passageway not visible in the sectioned view of FIG. 5. Likewise, the liquid fuel inlet 102 is fluidly connected to a liquid nozzle chamber 115 via a passageway not visible in the sectioned view of FIG. 5. In the embodiment shown, the liquid nozzle chamber 115 is separated from the gaseous nozzle chamber 114 by a check guide area 118 associated with gaseous check valve member 110. Although other locations exist, such as where the coaxial quill 54 contacts the common conical seat 27 of injector body 100, migration of one fuel into the other fuel is possible in the guide clearance that exists in check guide area 118. Migration of gaseous fuel from gaseous nozzle chamber 114 into liquid nozzle chamber 115 can be inhibited by maintaining the liquid fuel pressure in liquid fuel common rail 41 higher than the pressure in gaseous fuel common rail 40. For instance, at rated conditions, the liquid fuel rail 41 might be maintained at about 40 MPa, whereas the gaseous fuel common rail might be maintained at about 35 MPa. At idle, the respective liquid and gas rail pressures might be maintained at 25 and 20 MPa, respectively. This pressure differential may inhibit gaseous fuel from migrating into the liquid fuel, but may permit a small amount of liquid fuel to migrate along guide area 118 from liquid nozzle chamber 115 to gaseous nozzle chamber 114. This small amount of leakage may be beneficial for lubricating both the check guide area 118 and the seat 108 associated with gaseous check valve member 110.

Injector body 100 defines a gaseous nozzle outlet set 103, a liquid nozzle outlet set 104 and a drain outlet 105. Disposed within injector body 100 are a first control chamber 106 and a second control chamber 107. A gaseous check valve member 110 has a closing hydraulic surface 112 exposed to fluid pressure in the first control chamber 106. The gaseous check valve member 110 is movable between a closed position, as shown, in contact with a first nozzle seat 108 to fluidly block the gaseous fuel inlet 101 to the gaseous nozzle outlet set 103, and an open position out of contact with the first nozzle seat 108 to fluidly connect the gaseous fuel inlet 101 to the gaseous nozzle outlet set 103. First control chamber 106 may be partially defined by a first sleeve 111.

A liquid check valve member 120 has a closing hydraulic surface 121 exposed to fluid pressure in the second control chamber 107. The liquid check valve member 120 is movable between a closed position, as shown, in contact with a second nozzle seat 113 to fluidly block the liquid fuel inlet 102 to the liquid nozzle outlet set 104, and an open position out of contact with the second nozzle seat 113 to fluidly connect the liquid fuel inlet 102 to the liquid nozzle outlet set 104. The second control chamber 107 may be partially defined by a second sleeve 122. Thus, injection of gaseous fuel through gaseous nozzle outlet set 103 is facilitated by movement of gaseous check valve member 110, while injection of a liquid fuel through liquid nozzle outlet set 104 is facilitated by movement of the liquid check valve member 120.

A first control valve member 130 is positioned in injector body 100 and is movable along a common centerline 125 between a first position in contact with first valve seat 150 at which the first control chamber 106 is fluidly blocked to the drain outlet 105, and a second position at which the first control chamber 106 is fluidly connected to the drain outlet 105. When first control chamber 106 is fluidly connected to drain outlet 105, pressure in first control chamber 106 drops, relieving pressure on closing hydraulic surface 112 to allow gaseous check valve member 110 to lift to facilitate an injection of the gaseous fuel through gaseous nozzle outlet set 103. A second control valve member 135 is positioned in the injector body 100 and movable along the common centerline 125 between a first position in contact with second valve seat 155 at which the second control chamber 107 is fluidly blocked to the drain outlet 105, and a second position at which the second control chamber 107 is fluidly connected to the drain outlet 105. When second control chamber 107 is fluidly connected to drain outlet 105, fluid pressure acting on closing hydraulic surface 121 is relieved to allow liquid check valve member 120 to lift to an open position to facilitate injection of the liquid diesel fuel through the liquid nozzle outlet set 104.

In the illustrated embodiment, the first and second control valve members 130, 135 are intersected by the common centerline 125. The respective control valve members 130, 135 may be moved to one of their respective first and second positions with first and second electrical actuators that include first and second coils 147, 148, respectively. The control valve members 130, 135 may be biased to the their respective first positions by a shared biasing spring 146. A first armature 141 may be attached to a pusher 145 in contact with first control valve member 130. A second armature 142 may be operably coupled to move the second control valve member 135 by way of a pusher 143. A shared stator 144 houses first and second coils 147, 148 and separates the first armature 141 from the second armature 142.

In the illustrated embodiment, the first control chamber 106 may always be fluidly connected to the high pressure in the liquid fuel inlet 102 via an F orifice 160 and a Z orifice 161. The upstream ends of respective F and Z orifices 160 and 161 may be fluidly connected to the liquid fuel inlet 102 via passages not visible in the sectioned views. The first control chamber 106 is fluidly connected to a control passage 133 via a so called A orifice 163. Thus, when first control valve member 130 lifts off of first valve seat 150, the second fuel inlet 102 becomes fluidly connected to the drain outlet 105 through a Z-A pathway 116 and an F pathway 117 that are fluidly in parallel with each other.

The second control chamber 107 may always be fluidly connected to the high pressure in liquid fuel inlet 102 via an F orifice 170 and a Z orifice 171. The upstream ends of respective F and Z orifices 170, 171 may be fluidly connected to the liquid fuel inlet 102 via passages not visible in the sectioned view. The second control chamber 107 is fluidly connected to a control passage 134 via a so-called A orifice 173. Thus, when the second control valve member 135 moves off of the second valve seat 155, the second fuel inlet 102 becomes fluidly connected to the drain outlet 105 through a Z-A pathway 126 and an F pathway 127 that are fluidly in parallel with each other.

Those skilled in the art will appreciate that the illustrated embodiment utilizes liquid diesel fuel to control movement of the gaseous check valve member 110 and the liquid check valve member 120 to facilitate control over gaseous fuel injection events and liquid diesel fuel injection events, respectively. Other control strategies would also fall within the scope of the present disclosure.

### INDUSTRIAL APPLICABILITY

The present disclosure applies broadly to any engine that utilizes two fluidly distinct common rails to deliver gaseous and liquid fuels to a single fuel injector associated with each engine cylinder. The present disclosure applies broadly to an engine diagnostic system that includes a serviceability algorithm configured to confirm depressurization of the common rails prior to servicing. The present disclosure is more particularly applicable to an engine diagnostic system that includes a service tool for confirming that the common rails are fully depressurized before proceeding with servicing. Finally, the present disclosure is specifically directed to a service tool in communication with an engine 20 and programmed to execute a serviceability algorithm configured to display pressure information for the gaseous fuel common rail 40 and the liquid fuel common rail 41 when the engine 20 is stopped.

Before stopping engine 20 for servicing, gaseous fuel is supplied from the gaseous fuel common rail 40 to each of the plurality of fuel injectors 30 by a respective co-axial quill assembly 54. Likewise, liquid fuel from a liquid fuel common rail 41 is supplied to each of the plurality of fuel injectors 30 by the same respective co-axial quill assemblies 54. When in operation, gaseous fuel is injected from each fuel injector 30 into an engine cylinder 22 responsive to a gaseous fuel injection signal communicated from electronic controller 50 to the fuel injector 30. In particular, a gaseous fuel injection event is initiated by energizing the upper electrical actuator (upper coil 147) to move armature 141 and first control valve member 130 downward out of contact with first valve seat 150. This fluidly connects control chamber 106 to drain outlet 105 to reduce pressure acting on closing hydraulic surface 112. The gaseous fuel check valve member 110 then lifts out of contact with first nozzle seat 108 to commence spray of gaseous fuel out of gaseous nozzle outlet set 103. The injection event is ended by de-energizing the upper electrical actuator to allow armature 141 and control valve member 130 to move upward under the action of spring 146 back into contact to close first valve seat 150. When this occurs, pressure abruptly rises in control chamber 106 acting on closing hydraulic surface 112 to push gaseous check valve member 110 back downward into contact with seat 108 to end the gaseous fuel injection event.

Also, liquid fuel from the fuel injector 30 is injected directly into engine cylinder 22 from the same fuel injector 30 responsive to a liquid fuel injection signal from electronic controller 50. In particular, a liquid fuel injection event is initiated by energizing the lower coil 148 to move armature 142 upward along common centerline 125. This causes pusher 143 to move second control valve member 135 out of contact with second valve seat 155. This in turn relieves pressure in control chamber 107 allowing liquid check valve member 120 to lift out of contact with second nozzle seat 113 to commence a liquid fuel injection event out of liquid nozzle outlet set 104. To end the liquid injection event, the lower electrical actuator (lower coil 148) is de-energized. When this is done, shared biasing spring 146 pushes armature 142 and second control valve member 135 back up into contact with second valve seat 155 to close the fluid connection between control chamber 107 and drain outlet 105. When this is done, pressure acting on closing hydraulic surface 121 quickly rises causing liquid check valve member 120 to move downward and back into contact with second nozzle seat 113 to end the liquid fuel injection event. Both liquid and natural gas injection events are ended by fluidly connecting the respective control chambers 107, 106 to the liquid fuel common rail 22 through respective F orifices 160, 170, and Z orifices 161, 171 that are fluidly in parallel.

Because of its high compression ratio (greater than 14:1) the injected liquid fuel will compression ignite in each of the respective engine cylinders 22. The injected gaseous fuel is ignited in a respective one of the engine cylinders responsive to the compression ignition of the liquid fuel.

On occasion, engine 20 will malfunction and a fault logged while also notifying an operator that engine 20 is in need of service. In addition, after a certain duration of operation, routine maintenance schedules may also require servicing of engine 20. Because engine 20 includes both a gaseous fuel common rail 40 and a liquid fuel common rail 41 that are maintained at relatively high pressures during engine operation, the present disclosure provides a strategy for confirming that those common rails are completely depressurized prior to initiating some servicing task on engine 20 and its associated dual fuel common rail system 29. In a typical scenario, engine 20 would be stopped prior to servicing, which may even be performed in the field, and a service tool 11 establishes a communication with electronic controller 50. In most instances, this communication link is wired, but a wireless communication link could also fall within the scope of the present disclosure. A serviceability algorithm is executed with service tool 11. When the engine is stopped, pressure information for the gaseous fuel common rail 40 and the liquid fuel common rail 41 are displayed responsive to execution of the serviceability algorithm.

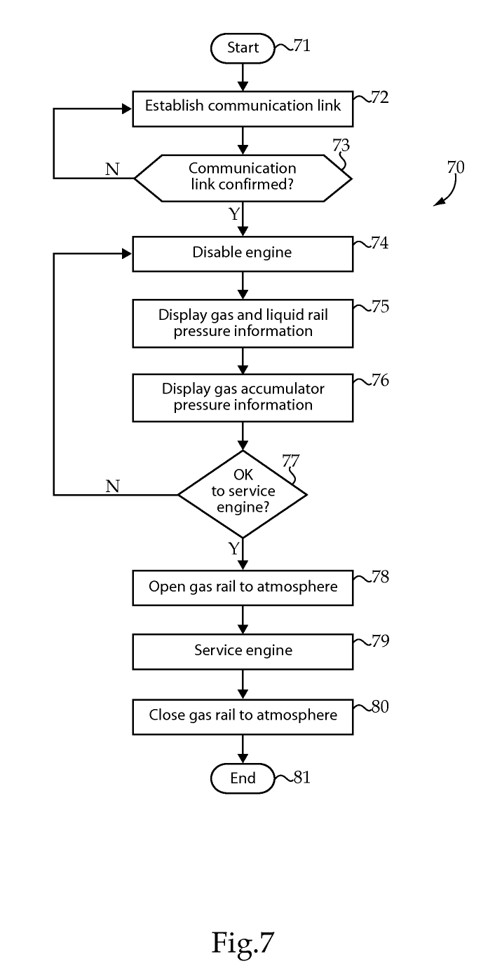

Referring now to FIG. 7, a flow diagram illustrating the logic of an example serviceability algorithm 70 according to one aspect of the present disclosure is illustrated. At oval 71, the algorithm starts and a communication link between service tool 11 and electronic controller 50 is established at block 72. At query 73, the logic confirms whether the communication link is up. If not, the logic loops back to block 72. If the communication link is confirmed the serviceability algorithm may act to disable operation of engine 20 at block 74, such as by preventing fuel injectors 30 from operating or via some manner known in the art. At block 75, pressure information for the gaseous fuel common rail 40 and the liquid fuel common rail 41 are displayed with service tool 11. As stated earlier, this pressure information can be relatively sophisticated or simply be a single bit of information indicating whether it is o.k. to service engine 20 in general and the dual fuel common rail system 29 in particular. At block 76, execution of the serviceability algorithm will also display pressure information for gas accumulator 33. Accumulator 33 may, and likely would be at a different pressure than gaseous fuel common rail 41 due in part to closure of shut off valve 45 responsive to shutting down of engine 20 and also due to the presence of intervening metering valve 35. Depending upon protocols, it might be possible to close manual isolation valve 60 to trap any pressurized gas in accumulator 33 so that servicing could proceed elsewhere in dual fuel common rail system 29. At query 77, the algorithm determines whether it is o.k. to service engine 20. If not, the logic loops back again to disable engine at block 74. If the displayed pressure information indicates that one or both of the common rails 40, 41 remains pressurized, some other protocol outside the scope of this disclosure may be deployed. For instance, if the liquid fuel common rail retains some residual pressure, some dry firing strategy may be utilized to quickly actuate and de-actuate injector control valves to move liquid fuel through fuel injectors 30 toward the drain outlets 105 to depressurize liquid fuel common rail 41. On the otherhand, if gaseous fuel common rail 40 retained some pressure, a protocol might include commanding venting valve 62 to open the gaseous fuel common rail 40 to atmosphere. If it is o.k. to service engine, the serviceability algorithm may command electronic controller 50 to open venting valve 62 for the duration of the servicing so that no build up of pressure could occur, for whatever reason, in the gaseous portion of dual fuel common rail system 29 during the servicing procedure. At block 79 some feature of engine 20 is serviced. After completing the servicing, the venting valve 62 may be closed to atmosphere. Depending upon what features or servicing is being performed, manual venting valve 61 may also be opened after confirming that it is o.k. to service engine 20 at query 77. When all servicing is complete, both venting valve 61 and venting valve 62 are closed and serviceability algorithm ends at oval 81.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An engine diagnostic system comprising:
an engine with a plurality of pistons that reciprocate in cylinders to define a compression ratio greater than 14:1, and including an electronic controller in control communication with a dual fuel common rail system;
the dual fuel common rail system including a gaseous fuel common rail and a liquid fuel common rail fluidly connected to a plurality of fuel injectors positioned for direct injection of gaseous fuel and liquid fuel directly into the cylinders; and
a service tool in communication with the electronic controller and programmed to execute a serviceability algorithm configured to display pressure information for the gaseous fuel common rail and the liquid fuel common rail when the engine is stopped.

2. The engine of claim 1 wherein the serviceability algorithm is configured to disable operation of the engine.

3. The engine of claim 1 including a venting valve movable between a first configuration at which the gaseous fuel common rail is fluidly blocked to atmosphere, and a second configuration at which the gaseous fuel common rail is fluidly connected to atmosphere.

4. The engine of claim 1 including an accumulator fluidly positioned between a vaporizer and the gaseous fuel common rail; and
wherein the serviceability algorithm is also configured to display pressure information for the accumulator.

5. The engine of claim 1 wherein the dual fuel common rail system includes exactly one fuel injector with a gaseous nozzle outlet set and a liquid nozzle outlet set for each of the cylinders.

6. The engine of claim 5 wherein the dual fuel common rail system includes a gas supply regulator valve fluidly positioned between an accumulator and the gaseous fuel common rail.

7. The engine of claim 6 wherein each fuel injector has a gaseous fuel injection configuration at which a liquid fuel inlet is fluidly connected to a drain outlet, and a gaseous fuel inlet is fluidly connected to the gaseous nozzle outlet set.

8. The engine of claim 7 wherein the serviceability algorithm is configured to disable operation of the engine.

9. The engine of claim 8 including a venting valve movable between a first configuration at which the gaseous fuel common rail is fluidly blocked to atmosphere, and a second configuration at which the gaseous fuel common rail is fluidly connected to atmosphere.

10. The engine of claim 9 including the accumulator being fluidly positioned between a vaporizer and the gaseous fuel common rail; and
wherein the serviceability algorithm is also configured to display pressure information for the accumulator.

11. A method of operating an engine diagnostic system that includes an engine with a plurality of pistons that reciprocate in cylinders to define a compression ratio greater than 14:1, and including an electronic controller in control communication with a dual fuel common rail system that includes a gaseous fuel common rail and a liquid fuel common rail fluidly connected to a plurality of fuel injectors positioned for direct injection of gaseous fuel and liquid fuel directly into the cylinders; and, a service tool, the method comprising the steps of:
establishing a communication between the service tool and the electronic controller;
executing a serviceability algorithm with the service tool;
with the engine stopped, displaying pressure information for the gaseous fuel common rail and the liquid fuel common rail responsive to execution of a serviceability algorithm.

12. The method of claim 11 including disabling operation of the engine responsive to execution of the serviceability algorithm.

13. The method of claim 11 including fluidly connecting the gaseous rail to atmosphere by moving venting valve from a first configuration at which the gaseous fuel common rail is fluidly blocked to atmosphere to a second configuration at which the gaseous fuel common rail is fluidly connected to atmosphere.

14. The method of claim 11 including displaying pressure information for an accumulator, which is fluidly positioned between a vaporizer and the gaseous fuel common rail, responsive to execution of the serviceability algorithm.

15. The method of claim 11 wherein the dual fuel common rail system includes exactly one fuel injector with a gaseous nozzle outlet set and a liquid nozzle outlet set positioned for direct injection into each of the cylinders.

16. The method of claim 15 including displaying pressure information for an accumulator, which is fluidly positioned between a vaporizer and the gaseous fuel common rail, responsive to execution of the serviceability algorithm.

17. The method of claim 16 including disabling operation of the engine responsive to execution of the serviceability algorithm.

18. The method of claim 17 including fluidly connecting the gaseous rail to atmosphere by moving venting valve from a first configuration at which the gaseous fuel common rail is fluidly blocked to atmosphere to a second configuration at which the gaseous fuel common rail is fluidly connected to atmosphere.
